(19) United States
(12) Patent Application Publication
(10) Pub. No.: US 2025/0278865 A1
(43) Pub. Date: Sep. 4, 2025

(54) Fidelity Analysis for Compression of Data

(71) Applicant: Analog Devices International Unlimited Company, Limerick (IE)

(72) Inventors: Gopal Gudhdur KARNAM, Koenigsbrunn (DE); Niall D. O'CONNELL, Clarina (IE); Andrew Michael CALDWELL, Peebles (GB)

(21) Appl. No.: 19/068,871

(22) Filed: Mar. 3, 2025

Related U.S. Application Data
(60) Provisional application No. 63/560,985, filed on Mar. 4, 2024.

(51) Int. Cl. G06T 9/20; G06T 7/13

(52) U.S. Cl. CPC G06T 9/20; G06T 7/13

(57) ABSTRACT

A method for transmitting data, comprising obtaining data, compressing the data to form compressed data, decompressing the compressed data to generate reconstructed data, comparing the data and the reconstructed data to generate a fidelity metric of the compressed data, and transmitting the compressed data with metadata comprising the fidelity metric.

### CROSS-REFERENCE TO RELATED APPLICATIONS

This application claims the benefit of and priority to U.S. Provisional Patent Application No. 63/560,985, filed Mar. 4, 2024, the contents of which application are hereby incorporated by reference herein in its entirety.

### TECHNICAL FIELD

The present invention relates to a method of transmitting data, including the compression of the data and generation of a fidelity metric relating to the compressed data. There is also provided a method of receiving data.

### BACKGROUND

Compression of image and video data is used in many systems to save bandwidth for transmission and reduce storage size for later retrieval. Compression techniques, such as rate control and rate-distortion optimization, aim to achieve the best possible quality at a given bit rate, often based on a capacity of a communication link. These methods adjust compression parameters, like quantization, to meet specific target bit rates, ensuring a near-constant flow rate of data. However, this approach may result in the transmitted data's accuracy or quality being insufficient for use in certain systems, particularly those requiring high accuracy and reliability.

Advanced Driver Assistance Systems (ADAS) are increasingly integrated into vehicles, relying on multiple data streams and types to function effectively. For instance, ADAS may use image data from one or more image sensors on the vehicle to make critical decisions about vehicle operation. The link bandwidth of a communication link connecting the image sensor to a processor or control system configured to provide the ADAS functionality may be limited.

In addition, latency in communications can pose significant challenges for ADAS systems. Low latency is crucial for real-time processing and decision-making, as delays in data transmission can lead to slower response times or data being received that is no longer useful to control vehicle operation due to latency.

### SUMMARY OF INVENTION

According to a first aspect, there is provided a method of compressing data, comprising obtaining data; compressing the data to form compressed data; decompressing the compressed data to generate reconstructed data; comparing the data and the reconstructed data to generate a fidelity metric of the compressed data; and outputting the compressed data with metadata comprising the fidelity metric.

According to a second aspect, there is provided a method comprising obtaining data comprising compressed data and metadata, the metadata comprising a fidelity metric of the compressed data; decompressing the compressed data to generate reconstructed data; and determining, in dependence on the fidelity metric, whether the reconstructed data is suitable for use.

According to a third aspect, there is provided a computer program that, when executed, causes one or more processors to perform the method.

### BRIEF DESCRIPTION OF THE DRAWINGS

Aspects of the present disclosure are described, by way of example only, with reference to the following drawings, in which:

FIG. 1 is a schematic diagram of a transmission system;

FIG. 2A is a schematic diagram of a transmission system comprising a decompression system and a fidelity metric generation system;

FIG. 2B is a schematic diagram of a transmission system, where a compression system comprises a decompression system;

FIG. 3 is a flowchart depicting a method for transmitting data;

FIG. 4 is an image divided into multiple segments;

FIG. 5 is a simplified image divided into multiple segments;

FIG. 6 is a graph indicating a first timing of the different method steps;

FIG. 7 is a graph indicating a second timing of the different method steps;

FIG. 8 is a graph indicating a third timing of the different method steps;

FIG. 9 is a graph indicating a fourth timing of the different method steps;

FIG. 10 is a flowchart of a method for receiving data; and

FIG. 11 shows an example computing environment.

### DETAILED DESCRIPTION

Advanced Driver Assistance Systems (ADAS) in vehicles allow automated control of one or more vehicle systems without human intervention, with minimal human intervention or with human monitoring. These systems may rely on real-time image data from multiple sensors to make critical decisions about vehicle operation. Increasing numbers of image sensors within the vehicle and the increasing definition of those image sensors may introduce issues relating to the available communication link-capacity of the vehicle. Transmitting raw image data can be challenging due to bandwidth limitations, however may be preferred due to the high accuracy of the transmitted data. Compressing the data may allow more data to be transmitted using the same link, however it may result in reduced accuracy and increased latency.

To address these challenges the fidelity or accuracy of compressed data may be assessed and communicated or transmitted with the compressed data. To allow this assessment of fidelity or accuracy, the data is compressed and then decompressed, allowing a fidelity metric to be generated based on a comparison of the original data and the decompressed data. This comparison of the original data and the decompressed data may be indicative of the accuracy of the compression process. The fidelity metric is transmitted with the compressed data, and end-user application may use the fidelity metric to determine the accuracy of the provided data or decompressed data and whether it is suitable for use in one or more systems, such as ADAS, based on the requirements of that system. This ensures that the transmitted data maintains quantifiable accuracy and quality.

Decompressing the data provides reconstructed data that may have one or more errors or differences compared to the original image data. By comparing the original data with the decompressed data, a fidelity metric provides a measurable indication of how closely the reconstructed data matches the original. Transmitting compressed data reduces the link capacity required for the vehicle, whilst the fidelity metric allows end-applications to ensure that they are operating on data of sufficient accuracy.

To reduce the latency of the system, the compression, decompression or reconstruction and determination or generation of the fidelity metric may take place in parallel. Parallel processing ensures that the system can handle large volumes of data efficiently while maintaining high accuracy and low latency.

Where the data represents an image, the data may be divided into one or more parts or groups, with each part or group of the data representing a part of the image. For example, each part of group may represent or be indicative of one or more pixels of the image. A part or group of the data may represent a vertical or horizontal strip of the image, or any other suitable sub-section of the image. Once the data is compressed, it may be immediately or in real-time decompressed to reconstruct the original image data. Both the compression process and the decompression may be performed in parallel. Each part or group of the image may be compressed and decompressed independently, allowing multiple parts or groups to be processed simultaneously. Further, one or more parts or groups of the image may be compressed by the system. Once those parts or groups of the image are compressed, they may then be decompressed and the fidelity metric determined for those parts or groups whilst the system goes on to compress further parts of the data.

The parallel processing of data compression, decompression, and fidelity metric determination may be particularly beneficial for real-time applications like ADAS. By dividing the image data into smaller parts, groups or segments and processing them simultaneously, the system can handle large volumes of data efficiently, ensuring minimal delay in data transmission and processing. This approach enhances the overall speed and efficiency of the system, allowing it to maintain high accuracy and low latency.

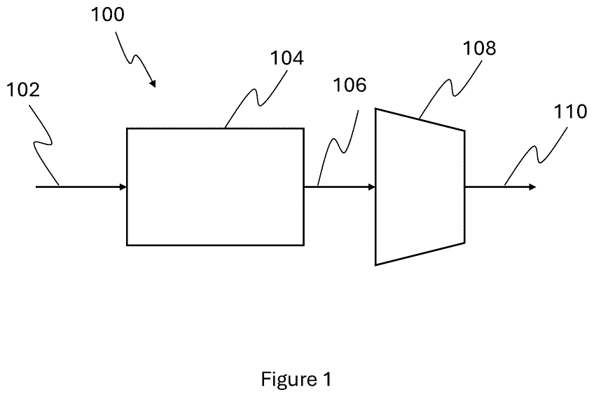

FIG. 1 shows a transmission system or transmitter 100. Data 102 is received or obtained by the transmission system 100 and provided to an input of a compression system 104. The compression system 104 acts to compress the data 102 and outputs compressed data 106. The compressed data is output by the compression system 104 and provided to a system 108 for transmission of the data. The system 108 may package, packetize or otherwise encapsulate the data such that it is suitable for transmission. System 108 may modulate or encode the data, which may comprise performing additional computations on the data to transform that data into another format, The data 110 that is output by the transmission system 100 may be input to any suitable communication link. System 108 may comprise a matching circuit or circuitry that matches the impedance of the communication link coupled to the transmission system 100.

The compression system 104 may use any suitable compression algorithm, compressing the input data 102.

The compression system may use rate-distortion optimization, in which encoding decisions and bit allocations of the data are determined, such that for a given bit rate, the distortion caused by the compression is minimised. Distortion may be a measure of the loss of quality of the compressed data 106 compared to that of the input data 102. The bit rate of the output may be fixed or within fixed bounds, such that the rate-distortion optimisation comprises attempting to allocate the available compressed data bits within a group of pixels so that the distortion amongst those compressed pixels is minimised.

Alternatively, in some situations, the rate-distortion optimisations may be a trade off between the bit rate and the distortion.

The rate-distortion optimisation may be suited to a human end-user, with distortion judged based on human vision or perception.

Rate-distortion optimisation may attempt to maximize quality of the compressed data 106 for a given bitrate. For example, so that it may be communicated by a particular communication link. However, rate-distortion optimisation is not influenced by the faithfulness of the end data as per an application requirement of the end-user or end-system. Typically, it will provide the best quality attainable at a given bitrate but under some conditions this may not be suitable for the final application. The distortion metric, or how the distortion is judged, may also not be suitable for the requirements of the final application.

In some situations, such as advanced driver assistance systems (ADAS), the transmission system 100 may not be suitable, as the transmitted data may not be of an accuracy required for the ADAS system to trust the data.

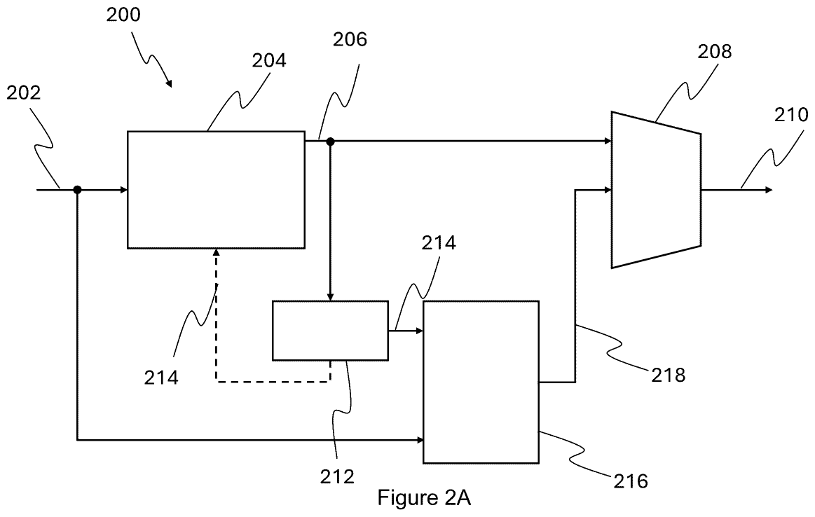

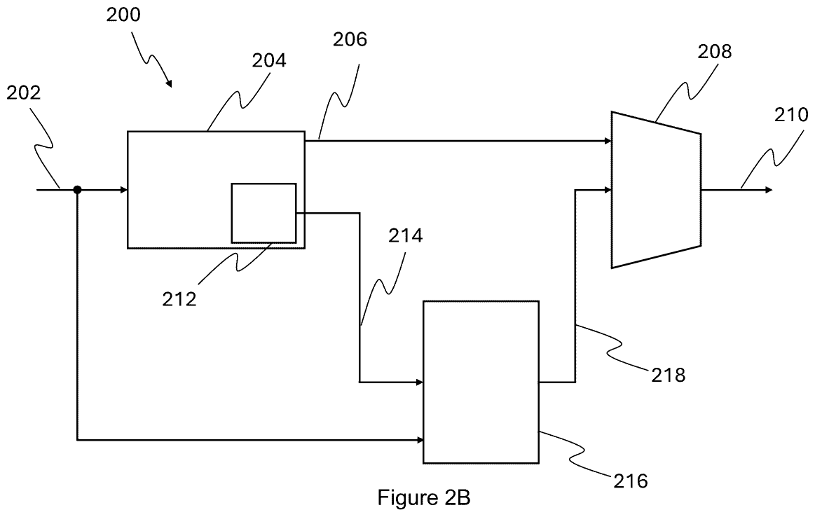

FIG. 2A shows a transmission system or transmitter 200. Input data 202 is received or obtained by the transmission system 200 and provided to an input of a compression system 204. The compression system 204 acts to compress the data 202 and outputs compressed data 206. The compressed data is output by the compression system 204 and provided to a system 208 for transmission of the data.

The transmission system 200 includes a decompression or reconstruction system 212. The decompression system 212 is configured to receive the compressed data 206 output by the compression system. The decompression system 212 decompresses the data 206 and outputs reconstructed data 214 to a fidelity metric generation system 216. The decompression system 212 may receive information as to the compression algorithm or compression performed by the compression system 204 so that it can accurately decompress the data 206.

The fidelity metric generation system 216 receives the reconstructed data 214 and the input data 202, which may also be referred to as the original data provided to the transmission system 200. The fidelity metric generation system 216 generates a fidelity metric 218 of the compressed data 206 through a comparison of the input data 202 and the reconstructed data 214. The fidelity metric 218 may be indicative of the accuracy of the reconstructed data 214 compared to the data 202, and as such may be indicative of the accuracy of the compression process provided by the compression system 204. The fidelity metric 218 is output or provided to the system 208.

System 208 receives the compressed data 206 and the fidelity metric 218 and transmits the compressed data 206 along with metadata comprising the fidelity metric 218. The metadata may be determined in any suitable manner based on the fidelity metric 218.

The system 208 may further perform any suitable computation on the compressed data 206 and the fidelity metric 218 to prepare it for transmission, for example serialising the data or parallelising the data depending on the communication link that the transmission system 200 is coupled to. System 208 may also package, packetize or otherwise encapsulate the data such that it is suitable for transmission. System 108 may modulate or encode the data, which may comprise performing additional computations on the data to transform that data into another format. The output data 210 that is output by the transmission system 100 comprises both the compressed data 206 and the metadata comprising the fidelity metric. The output data 210 may be input to any suitable communication link, including one or more communication links. System 208 may comprise a matching circuit or circuitry that matches the impedance of the communication link coupled to the transmission system 200. System 208 may include the generation of a cyclic redundancy check (CRC) based on the data which may be transmitted with the data, or any other error detection and/or correction coding.

Where the reconstructed data 214 is generated by a dedicated decompression system 212, the reconstructed or decompressed data 214 may be fed back to the compression system 204 (see dashed line 214). This may allow the compression system 204 or encoder to use prediction to leverage spatial redundancy. This may allow improved compression.

In some compression protocols (such as display stream compression) as each pixel of an image is compressed, a reconstructed/decompressed version of that pixel is produced by the compression system or stage 204. This allows the reconstructed/decompressed version of that pixel to be used as a reference or predictor when compressing the next pixel. As such, the decompression or reconstruction system 212 may be considered to be part of the compression system or stage 204. As such, in some systems, the decompressed data 214 may be readily available for use in generation of the fidelity metric without the need for a dedicated decompression stage or system 212.

FIG. 2B shows a transmission system or transmitter 200. FIG. 2B is similar to FIG. 2A, and like reference numerals refer to like parts of the transmission systems 200. As shown in FIG. 2B, the compression system 204 may comprise the decompression or reconstruction system 212. The compression system 204 may generate a reconstructed or decompressed version 212 of the compressed data 206 as well as the compressed data 206.

The systems of FIG. 2A and FIG. 2B include a number of different systems or elements, however it should be understood that these systems or elements may be combined in one or more different ways.

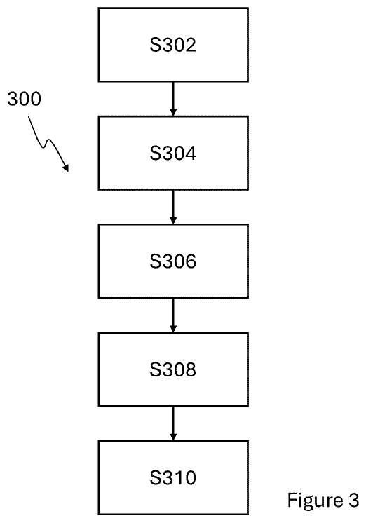

FIG. 3 is a flowchart 300 of a method for outputting data. The method includes steps S302-S308 which may be performed by any suitable control system or controller.

In a first step S302, the method comprises obtaining data 202. The data 202 may be referred to as input data 202. Obtaining the data 202 may comprise receiving the data 202 from an external system, receiving it from an internal or integrated system or obtaining the data 202 from a memory. The data 202 may be any type of data. The data 202 may be image data, such that the image data 202 represents an image. The image may be acquired using any suitable means, such as using an image sensor.

Step S304 comprises compressing the data 202 to form compressed data 206. The compression may use any suitable compression algorithm, as discussed previously.

Step S306 comprises decompressing the compressed data 206 to generate decompressed or reconstructed data 214.

Step S308 comprises comparing the input data 202 and the reconstructed data 214 to generate a fidelity metric of the compressed data. The reconstructed data 214 has been compressed and decompressed, and therefore comprises a number of differences or errors when compared to the original input data 202. By comparing the data 202 and the reconstructed data 214, the differences or errors may be quantised such that they can be represented by a metric indicative of an accuracy of the compression.

Step S310 comprises outputting the compressed data 206 along with metadata comprising the fidelity metric. By outputting both the compressed data 206 and the metadata comprising the fidelity metric, the transmission may be more efficient or require a lower bandwidth when compared to outputting uncompressed or raw data. The fidelity metric allows any receiving system to determine an accuracy of the received compressed data, and determine whether the accuracy is suitable for use in that system. This ensures that any data that is transmitted is only used in critical applications if the accuracy meets the specific requirements of that application.

Outputting the compressed data and the metadata may comprise outputting the data to a connected or coupled device, outputting to a transmitter or transmission system, transmitting the compressed data and the metadata or outputting to a shared memory resource. The shared memory resource may be shared with further systems, such as a receiver system which may receive or obtain the compressed data and the metadata from the shared memory resource. Any suitable means of outputting the data may be provided. Wherever the description refers to transmitting, it should be understood that this may refer to any suitable means of outputting the data.

As the fidelity metric is transmitted, the transmitting system 200 requires no or minimal knowledge of the end-use or application of the data. This allows the same transmission system to be used for a range of use cases, as the decision to use or discard the data is made after receipt of the data. This may also allow the end use application to use the data, but mark it with a trustworthiness or accuracy score indicative of the accuracy of the data.

The fidelity metric generated in step S308 may be any suitable metric of the accuracy of the compression of the data.

The data 202 may be representative of or indicative of an image, comprising a plurality of pixels. One or more objects may be present in the image, and the comparison of the representation of objects in the data 202 and reconstructed data 214 may be used to generate or determine the fidelity metric.

Compression of data may typically reduce detail around edges or details of objects represented in the images, particularly fine edges of the images. This may be the case where there is limited contrast between an object and surrounding features of the image. As such, the fidelity metric may be a metric as to the accuracy of the representation of edges in the compressed data. The data 202 and the reconstructed data 214 both represent the same image. As such, the edges of objects in the images represented by the data 202 and reconstructed data 214 may be identified and compared. The number of detected edges in the images represented by the data 202 and reconstructed data 214 may be compared, with the fidelity metric indicative of a difference in the number of edges in the images represented by the data 202 and reconstructed data 214. The edges may be identified in the images represented by the data 202 and reconstructed data 214 in any suitable manner, for example using Sobel or Canny operators.

As well as or instead of a comparison of the number of edges, the location of the edges within the images represented by the data 202 and reconstructed data 214 may be compared, with the fidelity metric indicative of a difference between the locations of edges, or any other suitable parameter related to the edges.

Compression of data may also reduce detail relating to key feature points within the images represented by the data 202 and reconstructed data 214, such as corners of objects present in the images represented by the data 202 and reconstructed data 214. Corners or other similar features may be necessary for the accuracy of vision-based models used in ADAS, and loss of corners may suggest feature or image degradation. The corners may be identified in the images represented by the data 202 and reconstructed data 214 using a Harris corner detector to determine the presence and location of Harris corner features. The fidelity metric may represent or be indicative of a difference in the corners determined in the images represented by the data 202 and reconstructed data 214, such as a difference in the number or location of corners.

The fidelity metric may comprise a structural similarity index (SSIM). The structural similarity index may be used to compare structural information between the image represented by the data 202 and the image represented by the reconstructed data 214. The structural similarity index may focus on one or more of a luminance of the images, a contrast of the images and a structure of the images. A structural similarity index may provide a numerical value for the fidelity metric. For example, the structural similarity index may vary between 1 and 0, where the closer to 1 the greater the similarity between the image represented by the data 202 and the image represented by the reconstructed data 214. The lower the structural similarity index, the greater the difference between the image represented by the data 202 and the image represented by the reconstructed data 214, indicating that the compression of the data 202 has corrupted the image or reduced the accuracy of the image represented by the compressed data 206.

The generation of the fidelity metric may comprise the generation of a peak signal to noise ratio (PSNR). A PSNR is a distortion-based metric, rather than a metric that identifies and compares specific features or objects within the image represented by the data 202 and the image represented by the reconstructed data 214. The PSNR may comprise determining a pixel-wise error between the pixels of the image represented by the data 202 and the pixels of the image represented by the reconstructed data 214. Determining the PSNR may comprise computing the mean squared error (MSE) and then expressing the ratio between the maximum possible pixel value and the distortion (MSE) decibels (dB) according to equation 1.

$$PSNR = 10 {log}_{10} ( \frac{{MAX}^{2}}{MSE} ) \qquad Equation 1$$

Generation of the fidelity metric may comprise determining a sum of absolute differences between the data 202 and the reconstructed data 214.

The generation of the fidelity metric may comprise computing or generating one or more of the above-described metrics. It should be understood that any other metric that is suitable for representing an accuracy of the compression of data may be used instead of or in addition to the above-described metrics. The fidelity metric may be tested with various AI or machine learning algorithms to determine which fidelity metric produces the best result for that particular algorithm.

As noted, the compression of the data may use rate-distortion optimization, in which encoding decisions and bit allocations of the data is determined such that the distortion caused by the compression is minimised for a fixed bit rate. In doing this, a distortion, measuring the loss of quality of the compressed data 206 compared to that of the input data 202 may be determined. This distortion measurement may be incorporated in the fidelity metric in addition to or in place of the described dedicated fidelity metric determinations. This may reduce the time or computation required to determine the fidelity metric.

A representation of an image may comprise a plurality of pixels. These pixels may be segmented into groups, parts or segments, and each of the groups, parts or segments may be processed individually. The image is represented by the data 202, the compressed data 206 and the reconstructed data 214. The data 202, the compressed data 206 and the reconstructed data 214 may also, therefore, be referred to as comprising a plurality of groups, segments or parts.

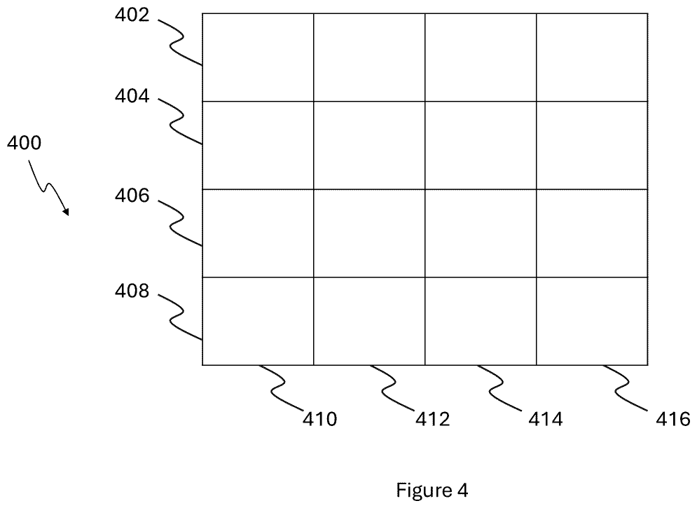

FIG. 4 is a figure of an image 400, comprising a plurality of rows 402-408 and a plurality of columns 410-416. The image also comprises a plurality of segments, created by the intersection of the rows and columns-representing 16 different segments in the image 400. These segments may be a sub-sections of the image 400. Further, the segments may be any suitable part of the image, and do not necessarily correspond to the rows and columns of the image 400.

The fidelity metric and each of the steps of the method 300 may be each performed, sequentially, on the entirety of the data-corresponding to computing the fidelity metric at the frame level of the image. This offers a simple implementation, where the data does not have to be segmented, and parallel processing is not required. However, to lower the latency, parallel processing of the data may be used instead, with the method performed on slices or parts of the image represented by the data. This may lower the processing time required to generate a fidelity metric, and thus reduce the communication latency to the end receiving system. This may be particularly beneficial where real-time data is required, such as in ADAS systems.

Rather than processing the data 202 representative of an image 400 as a single entity, the method 300 shown in FIG. 3 may be applied to each of the groups, segments or parts of the data in parallel. Each of the groups, segments or parts of the data may refer to a different row of the image 400, a different column of the image 400 or a different segment of the image 400.

Dividing the data 202 in this manner allows the data to be processed in parallel—it is not necessary to wait for the entirety of the data 202 to be compressed in step S304 before the decompression of the compressed data 206 in step S306 or the generation of the fidelity metric in step S308 occurs. As such, the method 300 of FIG. 3 may not be a strictly sequential process-two or more of the steps S304-310 may occur in parallel using different groups or parts of the data 202, compressed data 206 or reconstructed data 214.

For example, fidelity metrics may be generated for each of the rows 402-408, columns 410-416 or segments as soon as the data for that row, column or segment has been reconstructed. The system may then transmit the fidelity metric along with that row 402-408, column 410-416 or segment of the image 400 represented by the data. Where the data is processed in a certain manner (for example the data is processed in rows), it may be possible to generate a fidelity metric for the columns by buffering the data. Generating a different or separate fidelity metric for each of the parts of the data may allow the end user or application to judge an accuracy of that particular part of the data separate to the other parts. This may be particularly useful where different regions of an image represented by the data represent different things. For example, a first part of the image or data may represent a pedestrian along a foot path, road signs, the road itself or other road users. These parts of the data may be used in different systems, such as different parts of the ADAS, allowing the end application to perform a number of different judgements or operations based on the data.

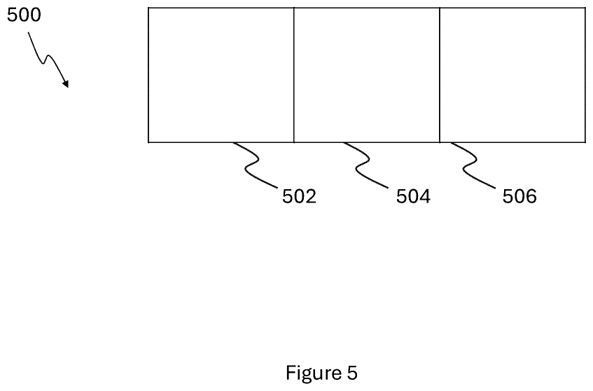

FIG. 5 shows a simplified image 500 comprising three groups or segments 502-506. These groups or segments of the image may each comprise a plurality of pixels of the image, corresponding to different columns of the image 500. As the data 202 represents an image, each of the groups, segments or parts 502-506 also corresponds to a segment or part of the data 202, the compressed data 206 and the reconstructed data 214.

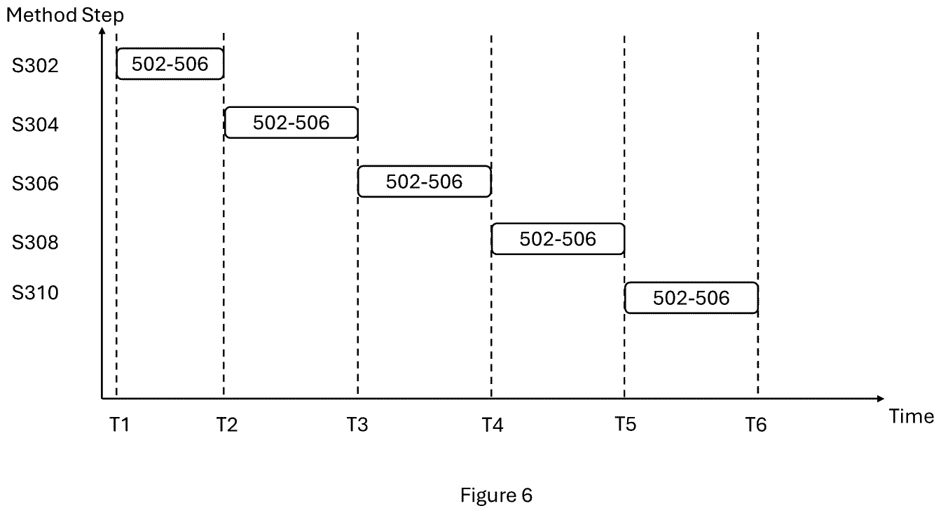

FIGS. 6-9 are graphs indicating the time at which different ones of the method steps S302-S310 are performed, and the data on which each of the method steps is performed. The X-axis shows time and the Y-axis represents the different method steps.

FIG. 6 shows the method performed in a sequential way, without segmentation of the data 202. In a first time period, between times T1-T2, the data corresponding to the entity of the image (segments 502-506 of the image) is obtained or received in step S302. Once the data has been obtained at time T2, the data 502-506 may be compressed in step S304 to form compressed data between times T2-T3. Once the data has been compressed at time T3 to form compressed data, the compressed data 206 may be decompressed to generate reconstructed data 214 in step S306 between times T3-T4. Once the reconstructed data 214 has been generated at time T4, the data 202 and the reconstructed data 214 may be compared in step S308 to generate a fidelity metric of the compressed data between times T4-T5. Once the fidelity metric has been generated at time T5, the compressed data with metadata comprising the fidelity metric may be transmitted between times T5-T6. The method may be complete at time T6, and may be restarted using new data or a different piece of data. Sequentially processing the data in the manner described with respect to FIG. 6 may result in a simple process, however it may increase system latency.

So as to reduce system latency, each of the parts 502-506 of the data 202 may be processed individually or in parallel.

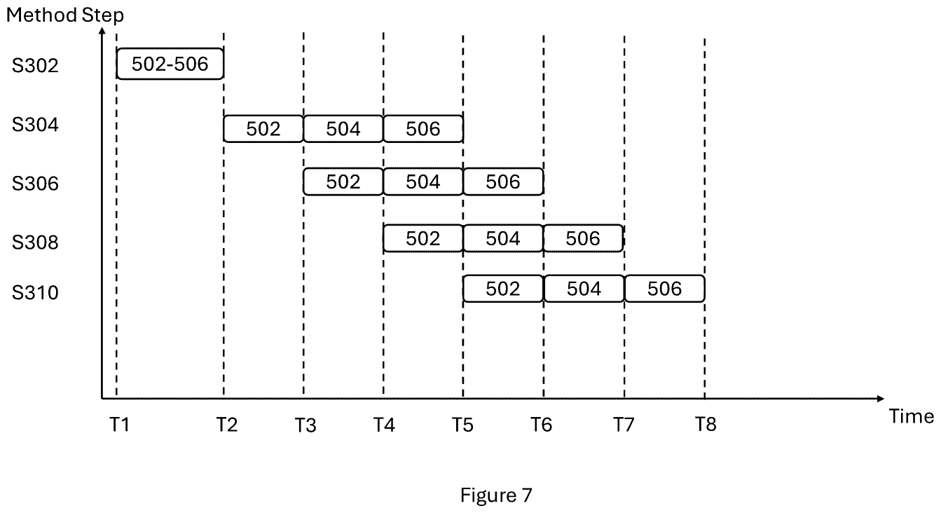

FIG. 7 shows the method performed in a parallel way, with segmentation of the data 202. In a first time period, between times T1-T2, the data corresponding to the entirety of the image (segments 502-506 of the image) is obtained or received in step S302. It should be understood that each of the parts of the data may instead be received individually, sequentially or in parallel. Once the data has been obtained at time T2, a first part 502 of the data 202 may be compressed between times T2-T3 to generate a first part 502 of the compressed data 206. Following the compression of the first part 502 of the data 202, at a time T3, a second part 504 of the data 202 may be compressed between times T3-T4 to form a second part 504 of the compressed data 206. Once the first part 502 of the compressed data 206 has been generated at time T3, the first part 502 of the compressed data 206 may be decompressed between times T3-T4 to generate reconstructed data in step S306. The compression of the second part 504 of the data 202 and the decompression of the first part 502 of the compressed data 506 occur in parallel, at the same time—in the between period T3-T4. It should be understood that there may be differences in the amount of time each method step takes, and the exact starting point of each method step, however they are shown in FIG. 7 as the same for ease of understanding.

At time T4, the second part 504 of the compressed data 206 has been generated in step S304 and the first part 502 of the reconstructed data 214 has been generated in step S306. Between times T4-T5, the third part 506 of the data 202 is compressed in step S304, the second part 504 of the compressed data 206 is decompressed in step S306 and the fidelity metric for the first part 502 of the reconstructed data 214 is generated in step S308.

At time T5, the third part 506 of the compressed data 206 has been generated in step S304, the second part 504 of the reconstructed data 214 has been generated in step S306 and the fidelity metric for the first part 502 of the data 202 has been generated in step S308. Between times T5-T6, the third part 506 of the compressed data 206 is decompressed in step S306, the fidelity metric for the second part 504 of the reconstructed data 214 is generated in step S308 and the first part 502 of the compressed data 206 along with metadata comprising the fidelity metric for the first part 502 of the data 202 are transmitted in step S310.

It can be seen that the time taken to transmit the first part 502 of the compressed data 206 along with its fidelity metric is lower in FIG. 7 than the latency to transmit the entirety of the compressed data 206 in FIG. 6. This may be particularly useful where the data is image data, as the end user application may be able to begin processing the first part 502 of the compressed data 206 before the remaining parts are received. Further, providing fidelity metrics for different parts of the data allows the end user application to determine whether different parts of the data are more accurate than others, and use only the parts of the data 202 that are of sufficient fidelity or accuracy.

At time T6, the first part 502 of the compressed data 206 along with metadata has been transmitted in step S310, the fidelity metric for the second part 504 of the data 202 has been generated in step S308, and the third part 506 of the reconstructed data 214 has been generated in step S306. Between times T6-T7, the fidelity metric for the third part 506 of the reconstructed data 214 is generated in step S308 and the second part 504 of the compressed data 206 along with metadata comprising the fidelity metric for the second part 504 of the data 202 are transmitted in step S310.

At time T7, the second part 504 of the compressed data 206 along with metadata has been transmitted in step S310 and the fidelity metric for the third part 506 of the data 202 has been generated in step S308. Between times T7-T8, the third part 506 of the compressed data 206 along with metadata comprising the fidelity metric for the third part 506 of the data 202 are transmitted in step S310.

At time T8, the method may be complete for the data 202, as all parts of the data have been transmitted. The method may restart or continue to process a further piece of data.

In FIG. 7 a fidelity metric is generated individually for each part of the data, however a fidelity metric may be generated for all of the data at the same time.

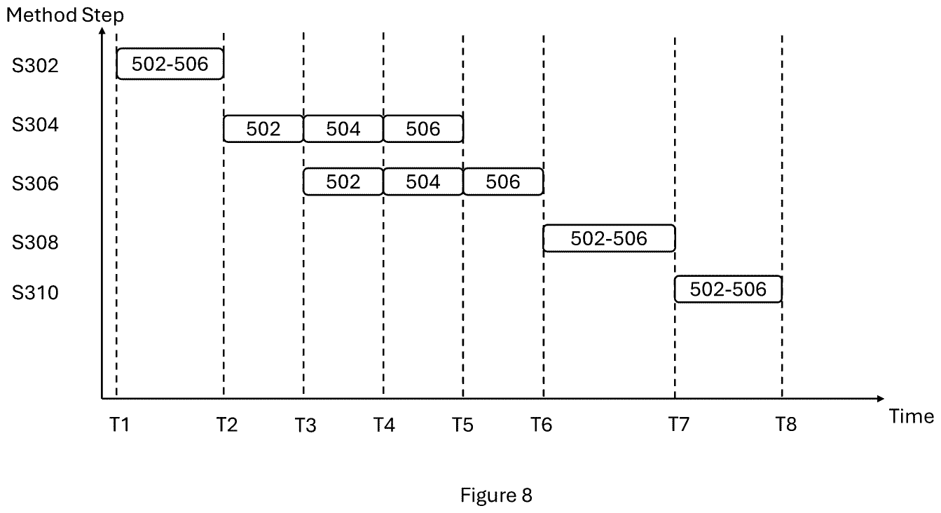

FIG. 8 shows the parallel compression in step S304 and decompression in step S306 of the parts of the data 502-506. A number of the parts of FIG. 8 are the same as those of FIG. 7, and so will not be described in detail again here. At time T6, all of the parts 502-506 of the compressed data 206 have been decompressed in step S306. Between times T6-T7 a combined fidelity metric may be generated for all of the parts 502-506 of the data. This may then be transmitted in a single transmission between times T7-T8. By compressing and decompressing the data in this manner, the time to decompress all of the data may be reduced when compared to the method of FIG. 6. Further, it may allow a combined fidelity metric to be generated for all of the data. Where the fidelity metric includes a non-linear operation that has to be applied to the entire image, the process shown in FIG. 8 allows reduced latency whilst still allowing the fidelity metric to be generated using the chosen metric.

A fidelity metric may be generated for each of the parts of the data 502-506 individually and then combined. The processing operation to generate a fidelity metric may be divided into multiple parts. For example, a first operation may generate a first fidelity metric and be performed on the parts 502-506 individually (as shown in FIG. 7). Following the generation of a first fidelity metric for each of the parts 502-506 of the data in the first operation, a second or further operation of the fidelity metric generation may take place to generate a second fidelity metric for all of the data 502-506 together. In this way, the first fidelity metric that can be generated for each part of the data individually is generated in an efficient manner in parallel. It may only be possible to generate the second fidelity metric on all of the parts of the data together. However, as the first fidelity metric has already been generated, the operation may be more efficient than waiting for all of the reconstructed data 214 to be available. The first fidelity metric and the second fidelity metric may be combined and transmitted with the compressed data 206.

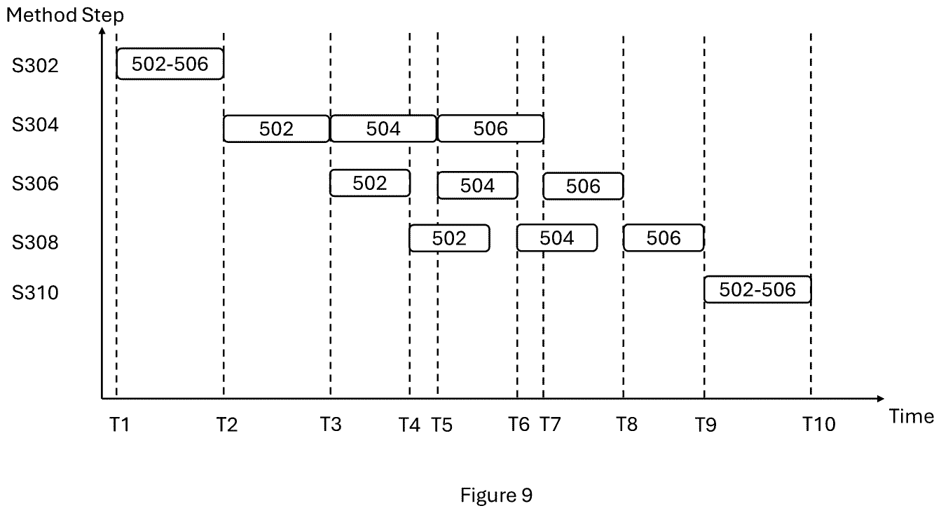

It should be understood that each of the method steps may take a different period of time compared to the other method steps. Further, the time taken for each method step may vary depending on the type of data or content of the data that is processed. As shown in FIG. 9, the time taken for each of the compression (step S304), decompression (S306) and generation of the fidelity metric (S308) may be different. This may result in periods (such as between times T4-T5) where one of the method steps cannot be completed.

FIGS. 7-9 show the method performed such that each of the respective method steps is performed in parallel to a different method step. However, each of the respective method steps is performed sequentially on the data (i.e. in FIG. 9, only one part of the data is decompressed at any one time, followed by the further parts of the data). It should be understood that each respective method step may be formed in parallel on the data-such two or more parts 502-506 of the data are undergoing an operation of one of the method steps S302-S310 at any one time.

The metadata comprising the fidelity metric and the compressed data 206 may be transmitted using the same communication link. Alternatively, they may be transmitted using different communication links.

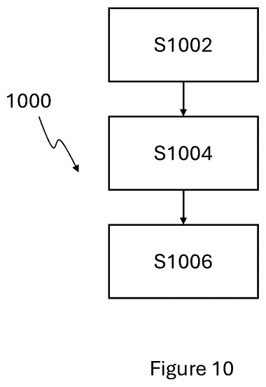

FIG. 10 shows a method 1000. The method 1000 may be a method for receiving, obtaining or using data.

In a first step, S1002, the method comprises obtaining data comprising compressed data and metadata. The metadata comprises a fidelity metric of the compressed data. The fidelity metric and compressed data may be generated in any of the ways described previously, or any other suitable manner. The data comprising compressed data and metadata may be received from a transmission system following the method of FIG. 3, or any other suitable transmission system.

Obtaining the data may comprise obtaining, receiving or retrieving the data comprising compressed data and metadata from another device, from a software package, from a shared memory of a system, from a memory or from a receiving system such as an antenna or communication link.

In a second step, S1004, the method comprises reconstructing the compressed data to generate reconstructed data. The reconstruction or decompression process may be any suitable means for decompressing the data. The receiving system may receive information as to the compression process performed at the transmission system, for example in a header of the received data.

In a third step, S1006, the method comprises determining, in dependence on the fidelity metric, whether the reconstructed data is suitable for use. This may be in dependence on the application that the receiving system is coupled to, and the required accuracy of the operations performed by the end-use application. Suitable for use may mean that the data is suitable or acceptable for use for a particular purpose or application or suitable for use for any one or more different purposes or applications, such as ADAS, or other systems such as a rear-view camera, a front view camera etc. The application may comprise a software function, or module, or a hardware function or module of a vehicle, such as an ADAS function or module.

The reconstructed data may be provided to the application, and the determination as to whether to use the data may take place at the application itself or in the receiving system. Determining whether to use the reconstructed data comprises determining, in dependence on the fidelity metric, whether the reconstructed data is of sufficient accuracy for use in the application.

The fidelity metrics described herein may be tailored to a specific application (such as an ADAS system for a vehicle) and specific type of data (such as image data). However, it should be understood that the fidelity metrics may be chosen such that they are suitable for different data types and/or different applications. For example, in a vehicle, data may be provided to ADAS systems (or similar automated systems) or provided for human use. For example, the method and fidelity metrics described above may be applied to data for use in display side interfaces of a vehicle, such as data for displaying on a screen of the vehicle. The data may be mainly for human consumption, but faithful reproduction may still be important for the display of safety-relevant information (such as a door open indicator, a speed limit). The fidelity metrics may focus on different parts of the data or be configured differently based on the end use of the data.

The transmission system 200 shown in FIGS. 2A and 2B includes a number of distinct blocks, circuits or systems. It should be understood that these distinct elements may instead be combined in one or more different ways and may comprise analog or digital circuitry configured to perform the method steps. The transmission system may additionally or alternatively comprise a control system comprising one or more processors configured to perform the methods described herein. The transmission system may comprise any suitable processor, such as a field programmable gate array (FPGA) or microcontroller.

The receiving system may similarly comprise any suitable circuit, control system or processor configured to perform the method of FIG. 10. A control system or system for implementing the described method may be implemented in a vehicle.

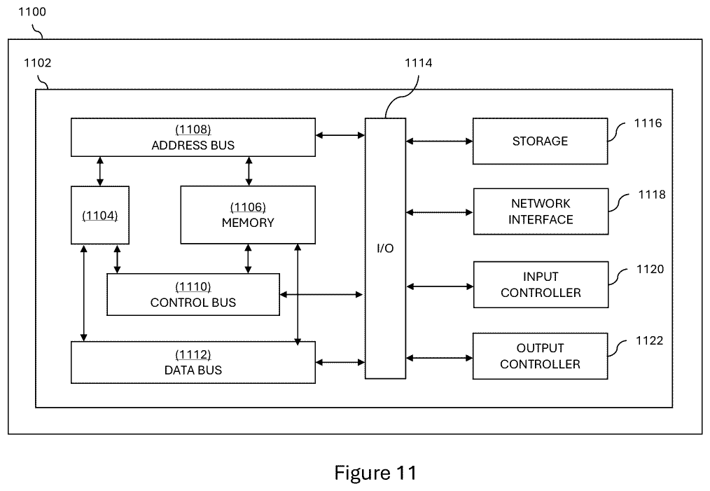

FIG. 11 shows an example computing system. Specifically, FIG. 11 shows a block diagram of an embodiment of a computing system according to example embodiments of the present disclosure.

Computing system 1100 can be configured to perform any of the operations disclosed herein such as, for example, any of the operations discussed with reference to the flowcharts or methods described in relation to FIGS. 3 and 10. Computing system includes one or more computing device(s) 1102. Computing device(s) 1102 of computing system 1100 comprise one or more processors 1104 and memory 1106. One or more processors 1104 can be any general-purpose processor(s) configured to execute a set of instructions. For example, one or more processors 1104 can be one or more general-purpose processors, one or more field programmable gate array (FPGA), and/or one or more application specific integrated circuits (ASIC). In one embodiment, one or more processors 1104 include one processor. Alternatively, one or more processors 1104 include a plurality of processors that are operatively connected. One or more processors 1104 are communicatively coupled to memory 1106 via address bus 1108, control bus 1110, and data bus 1112. Memory 1106 can be a random-access memory (RAM), a read only memory (ROM), a persistent storage device such as a hard drive, an erasable programmable read only memory (EPROM), and/or the like. Computing device(s) 1102 further comprise I/O interface 1114 communicatively coupled to address bus 1108, control bus 1110, and data bus 1112.

Memory 1106 can store information that can be accessed by one or more processors 1104. For instance, memory 1106 (e.g., one or more non-transitory computer-readable storage mediums, memory devices) can include computer-readable instructions (not shown) that can be executed by one or more processors 1104. The computer-readable instructions can be software written in any suitable programming language or can be implemented in hardware. Additionally, or alternatively, the computer-readable instructions can be executed in logically and/or virtually separate threads on one or more processors 1104. For example, memory 1106 can store instructions (not shown) that when executed by one or more processors 1104 cause one or more processors 1104 to perform operations such as any of the operations and functions for which computing system 1100 is configured, as described herein. In addition, or alternatively, memory 1106 can store data (not shown) that can be obtained, received, accessed, written, manipulated, created, and/or stored. The data can include, for instance, the data and/or information described herein in relation to any of FIGS. 2-10. In some implementations, computing device(s) 1102 can obtain from and/or store data in one or more memory device(s) that are remote from the computing system 1100.

Computing environment 1100 further comprises storage unit 1116, network interface 1118, input controller 1120, and output controller 1122. Storage unit 1116, network interface 1118, input controller 1120, and output controller 1122 are communicatively coupled to the central control unit via I/O interface 1114.

Storage unit 1116 is a computer readable medium, preferably a non-transitory computer readable medium, comprising one or more programs, the one or more programs comprising instructions which when executed by the one or more processors 1104 cause computing environment 1100 to perform the method steps of the present disclosure. Alternatively, storage unit 1116 is a transitory computer readable medium. Storage unit 1116 can be a persistent storage device such as a hard drive, a cloud storage device, or any other appropriate storage device.

Network interface 1118 can be a Wi-Fi module, a network interface card, a Bluetooth module, and/or any other suitable wired or wireless communication device. In an embodiment, network interface 1118 is configured to connect to a network such as a local area network (LAN), or a wide area network (WAN), the Internet, or an intranet. Network interface 1118 may receive, obtain, output or transmit any data as described herein.

The above illustrative examples of various aspects and implementations provide an overview for understanding aspects and implementation of the disclosed method. The figures provided herein depict exemplary aspects of the present system and methods and are not intended to limit the scope of the disclosure.

The methods described herein can be implemented in software or a computer program, such as one stored on a non-transitory computer readable medium, comprising instructions that when executed on one or more processors (for example, on a microprocessor(s)) cause the processors to perform the method.

Unless otherwise stated, all technical terms used herein have the same meaning as commonly understand by a person skilled in the art. Singular forms “a”, “an” and “the” include plural references unless the context of the disclosure clearly dictates otherwise. The term “or” is intended to encompass “and/or” unless clearly stated otherwise.

The above illustrative examples of various aspects and implementations refer to prediction models or machine learning models.

The terminology “coupled” used herein encompasses both a direct connection between two components/devices/systems, and an indirect electrical connection where the two components/devices/system are connected to each other via one or more intermediate components/devices/systems.

### Numbered Aspects

Included below is a set of numbered aspects:
Aspect 1. A method of compressing data, comprising:
   obtaining data;
   compressing the data to form compressed data;
   decompressing the compressed data to generate reconstructed data;
   comparing the data and the reconstructed data to generate a fidelity metric of the compressed data; and
   outputting the compressed data with metadata comprising the fidelity metric.
Aspect 2. The method according to Aspect 1, wherein the fidelity metric is indicative of an accuracy of the reconstructed data.
Aspect 3. The method according to any preceding Aspect, wherein the data represents an image.
Aspect 4. The method according to Aspect 3, wherein comparing the data and the reconstructed data to generate a fidelity metric of the compressed data comprises:
   determining a presence of one or more edges or corners of one or more objects within the image represented by the data;
   determining a presence of one or more edges or corners of one or more objects within the image represented by the reconstructed data; and
   comparing the one or more edges or corners in the image represented by the data to the one or more edges or corners in the image represented by the reconstructed data.
Aspect 5. The method according to Aspect 4, wherein determining the presence of one or more edges comprises using Sobel or Canny operators.
Aspect 6. The method according to Aspect 4 or Aspect 5, wherein determining the presence of one or more corners comprises using a Harris corner detector.
Aspect 7. The method according to any of Aspects 4-6, wherein comparing the one or more edges or corners in the image represented by the data to the one or more edges or corners in the image represented by the reconstructed data comprises comparing the number of detected edges or corners in each of the images represented by the data and reconstructed data.
Aspect 8. The method according to any of Aspects 3-7, wherein comparing the data and the reconstructed data to generate the fidelity metric comprises:
   generating a structural similarity index between the image represented by the data and the image represented by the reconstructed data.
Aspect 9. The method according to any of Aspects 3-8, wherein comparing the data and the reconstructed data to generate the fidelity metric comprises:
   determining a sum of absolute differences between the data and the reconstructed data.
Aspect 10. The method according to any of Aspects 3-9, wherein comparing the data and the reconstructed data to generate the fidelity metric comprises:
   determining a peak to signal noise ratio, PSNR, between the data and the reconstructed data.
Aspect 11. The method according to any preceding Aspect, wherein compressing the data to form compressed data comprises performing a rate-distortion optimization of the compression to minimise a measure of distortion of the compressed data for a fixed bitrate, and wherein the fidelity metric comprises the measure of distortion of the compressed data.
Aspect 12. The method according to any preceding Aspect, wherein at least one of the generation of the fidelity metric and the decompression of a part of the data occurs in parallel to compression of a further part of the data.
Aspect 13. The method according to any preceding Aspect, wherein the method comprises:
   compressing a part of the data to generate a part of the compressed data;
   compressing a further part of the data to generate a further part of the compressed data; and
   decompressing the part of the compressed data to generate a part of the reconstructed data,
   wherein decompressing the part of the compressed data takes place before, or in parallel with, compressing the further part of the data.
Aspect 14. The method according to any preceding Aspect, wherein the data comprises a plurality of parts, each part of the data indicative of a respective set of pixels of an image represented by the data, and
   wherein the reconstructed data comprises a plurality of parts, each part of the reconstructed data indicative of a respective set of pixels of an image represented by the reconstructed data, wherein each part of the data corresponds to a respective part of the reconstructed data.
Aspect 15. The method according to Aspect 14,
   wherein compressing the data to form compressed data comprises compressing each of the plurality of parts of the data to form a plurality of parts of the compressed data, and
   wherein decompressing the data to generate reconstructed data comprises decompressing each of the plurality parts of the compressed data to form the plurality of parts of the reconstructed data, and
   wherein comparing the data and the reconstructed data to generate the fidelity metric comprises comparing each of the plurality of parts of the data to a corresponding part of the plurality of parts of the reconstructed data to generate a fidelity metric for that part of the data.
Aspect 16. The method according to Aspect 15, wherein the decompression of one or more parts of the plurality of parts of the compressed data occurs prior to the completion of compression of all of the parts of the plurality of parts of the data.
Aspect 17. The method according to Aspect 15 or Aspect 16, wherein generating the fidelity metric for one or more parts of the plurality of parts of the data occurs prior to completion of decompression of all parts of the plurality of parts of the compressed data.
Aspect 18. The method according to any of Aspects 14-17, wherein the fidelity metric is generated for each of parts of the plurality of parts of the data independently to the other parts of the plurality of parts of the data by comparing each part of the plurality of parts of the data with the corresponding part of the plurality of parts of the reconstructed data.
Aspect 19. The method according to any of Aspects 14-18, wherein outputting the compressed data with metadata comprising the fidelity metric comprises:
   outputting compressed data relating to at least one part of the plurality of parts of data with respective metadata relating to that at least one part of the plurality of parts of the data.
Aspect 20. The method according to Aspect 19, wherein transmitting compressed data relating to the respective part of the data with metadata relating to that part of the data occurs in real time once the metadata for that part of the data has been generated.
Aspect 21. The method according to any of Aspects 18-20, further comprising combining the fidelity metric for each of the parts of plurality of parts of the data into a combined fidelity metric.
Aspect 22. The method according to Aspect 21, wherein the metadata comprises the combined fidelity metric.
Aspect 23. The method according to any preceding Aspect, wherein the metadata and the compressed data are transmitted using the same communication link.
Aspect 24. The method according to any of Aspects 1-22, wherein the metadata and the compressed data are transmitted using different communication links.
Aspect 25. A method comprising:
   obtaining data comprising compressed data and metadata, the metadata comprising a fidelity metric of the compressed data;
   decompressing the compressed data to generate reconstructed data; and
   determining, in dependence on the fidelity metric, whether the reconstructed data is suitable for use.
Aspect 26. The method according to Aspect 25. further comprising:
   providing the reconstructed data to an application.
Aspect 27. The method according to Aspect 26, wherein providing the reconstructed data to the application is dependent on the reconstructed data being determined as suitable for use by the application.
Aspect 28. The method according to any of Aspects 25-27, wherein the data is image data.
Aspect 29. An electronic device configured to perform the method according to any of Aspects 1-28.
Aspect 30. A non-transitory computer readable medium comprising instructions that, when executed, cause one or more processors to perform the method of any of Aspects 1-28.
Aspect 31. A computer program that, when executed, causes one or more processors to perform the method of any of Aspects 1-28.

1. A method of compressing data, comprising:
obtaining data;
compressing the data to form compressed data;
decompressing the compressed data to generate reconstructed data;
comparing the data and the reconstructed data to generate a fidelity metric of the compressed data; and
outputting the compressed data with metadata comprising the fidelity metric.

2. The method according to claim 1, wherein the fidelity metric is indicative of an accuracy of the reconstructed data.

3. The method according to claim 1, wherein the data represents an image.

4. The method according to claim 3, wherein comparing the data and the reconstructed data to generate a fidelity metric of the compressed data comprises:
determining a presence of one or more edges or corners of one or more objects within the image represented by the data;
determining a presence of one or more edges or corners of one or more objects within the image represented by the reconstructed data; and
comparing the one or more edges or corners in the image represented by the data to the one or more edges or corners in the image represented by the reconstructed data.

5. The method according to claim 3, wherein comparing the data and the reconstructed data to generate the fidelity metric comprises:
generating a structural similarity index between the image represented by the data and the image represented by the reconstructed data.

6. The method according to claim 3, wherein comparing the data and the reconstructed data to generate the fidelity metric comprises:
determining a sum of absolute differences between the data and the reconstructed data.

7. The method according to claim 1, wherein compressing the data to form compressed data comprises performing a rate-distortion optimization of the compression to minimise a measure of distortion of the compressed data for a fixed bitrate, and wherein the fidelity metric comprises the measure of distortion of the compressed data.

8. The method according to claim 1, wherein at least one of the generation of the fidelity metric and the decompression of a part of the data occurs in parallel to compression of a further part of the data.

9. The method according to claim 1, wherein the method comprises:
compressing a part of the data to generate a part of the compressed data;
compressing a further part of the data to generate a further part of the compressed data; and
decompressing the part of the compressed data to generate a part of the reconstructed data,
wherein decompressing the part of the compressed data takes place before, or in parallel with, compressing the further part of the data.

10. The method according to claim 1, wherein the data comprises a plurality of parts, each part of the data indicative of a respective set of pixels of an image represented by the data, and
wherein the reconstructed data comprises a plurality of parts, each part of the reconstructed data indicative of a respective set of pixels of an image represented by the reconstructed data, wherein each part of the data corresponds to a respective part of the reconstructed data.

11. The method according to claim 10,
wherein compressing the data to form compressed data comprises compressing each of the plurality of parts of the data to form a plurality of parts of the compressed data, and
wherein decompressing the data to generate reconstructed data comprises decompressing each of the plurality parts of the compressed data to form the plurality of parts of the reconstructed data, and
wherein comparing the data and the reconstructed data to generate the fidelity metric comprises comparing each of the plurality of parts of the data to a corresponding part of the plurality of parts of the reconstructed data to generate a fidelity metric for that part of the data.

12. The method according to claim 11, wherein the decompression of one or more parts of the plurality of parts of the compressed data occurs prior to the completion of compression of all of the parts of the plurality of parts of the data.

13. The method according to claim 11, wherein generating the fidelity metric for one or more parts of the plurality of parts of the data occurs prior to completion of decompression of all parts of the plurality of parts of the compressed data.

14. The method according to claim 10, wherein the fidelity metric is generated for each of parts of the plurality of parts of the data independently to the other parts of the plurality of parts of the data by comparing each part of the plurality of parts of the data with the corresponding part of the plurality of parts of the reconstructed data.

15. The method according to claim 10, wherein outputting the compressed data with metadata comprising the fidelity metric comprises:
outputting compressed data relating to at least one part of the plurality of parts of data with respective metadata relating to that at least one part of the plurality of parts of the data.

16. The method according to claim 15, wherein transmitting compressed data relating to the respective part of the data with metadata relating to that part of the data occurs in real time once the metadata for that part of the data has been generated.

17. The method according to claim 14, further comprising combining the fidelity metric for each of the parts of plurality of parts of the data into a combined fidelity metric.

18. The method according to claim 17, wherein the metadata comprises the combined fidelity metric.

19. A method comprising:
obtaining data comprising compressed data and metadata, the metadata comprising a fidelity metric of the compressed data;
decompressing the compressed data to generate reconstructed data; and
determining, in dependence on the fidelity metric, whether the reconstructed data is suitable for use.

20. A non-transitory computer readable medium comprising instructions that, when executed, cause one or more processors to perform the following steps:
obtaining data;
compressing the data to form compressed data;
decompressing the compressed data to generate reconstructed data;
comparing the data and the reconstructed data to generate a fidelity metric of the compressed data; and
outputting the compressed data with metadata comprising the fidelity metric.
